(19) United States
(12) Patent Application Publication
(10) Pub. No.: US 2024/0399302 A1
(43) Pub. Date: Dec. 5, 2024

(54) METHOD FOR REDUCING THE CONTENT OF NITROGEN OXIDES IN A FLUE GAS STREAM OF THERMAL WASTE TREATMENT PLANTS

(71) Applicants: LINDE GMBH, Pullach (DE); MARTIN GMBH FUR UMWELT- UND ENERGIETECHNIK, Munchen (DE)

(72) Inventors: Heinz-Dieter OBERMEYER, Pullach (DE); Johann KALTENEGGER, Pullach (DE); Sebastian JELL, München (DE); Ulrich MARTIN, München (DE)

(21) Appl. No.: 18/699,791

(22) PCT Filed: Oct. 12, 2022
(86) PCT No.: PCT/EP2022/025469

§ 371 Date: Apr. 9, 2024

(30) Foreign Application Priority Data
Oct. 12, 2021 (EP) 21020509.2

(51) Int. Cl. B01D 53/56; B01D 53/75

(52) U.S. Cl. CPC B01D 53/56; B01D 53/75; B01D 2251/104; B01D 2251/2062; B01D 2257/404; B01D 2258/0291

(57) ABSTRACT

A method for reducing the content of nitrogen oxides in a flue gas stream, in which method the flue gas stream is taken from a thermal plant for the treatment of garbage, domestic waste, and/or residual materials similar to domestic waste, and is passed through a secondary treatment unit designed for selective, non-catalytic reduction, and then is subsequently passed through a scrubbing, absorption, or adsorption unit. According to the invention, an ozone injection into the flue gas stream is carried out downstream of the secondary treatment unit and upstream of the washing, absorption, or adsorption unit. The present invention also relates to a corresponding plant.

The invention relates to a method and to an arrangement for reducing the content of nitrogen oxides in a flue gas stream of thermal waste treatment plants.

### BACKGROUND

Selective non-catalytic reduction (SNCR) and selective catalytic reduction (SCR) are proven secondary measures for reducing nitrogen oxides in flue gas. It is also known that ozone can effectively oxidize nitrogen oxides in flue gas streams. This was utilized in industrial applications, especially in refineries. When ozone is used, the same or even lower emissions can be achieved than in SCR and SNCR.

The technical background of the invention/the prior art is J. Kuropka, “Removal of Nitrogen Oxides from Flue gases in a Packed Column”, Environment Protection Engineering, vol. 37, no. 1, pp. 13-22, 2011, and a publication of the German Federal Environmental Agency, by M. Beckmann, “Description of different techniques and their development potentials for reducing nitrogen oxides in the exhaust gas of waste incineration plants”, Text 71/2011, 2011.

In the field of thermal waste treatment, ozone has not been used until now for reducing nitrogen oxides. The thermal treatment of garbage, domestic waste, and residual materials similar to domestic waste involves special requirements. Compared to other fuels, such as coal or gas, these substances are highly inhomogeneous in their composition, and have high variability in moisture and ash content. As a result of these unpredictable fluctuations in the composition of the waste fuel, there are particularly high demands placed on the control quality of the exhaust gas reduction measures following combustion.

The object of the present invention is to improve corresponding secondary measures for reducing nitrogen oxides in flue gas, and to overcome the disadvantages further discussed below. In addition, the invention addresses the particular challenges of waste as a fuel.

### DISCLOSURE OF THE INVENTION

Against this background, a method for reducing the content of nitrogen oxides in the flue gas of thermal waste treatment plants is proposed, having the features of the independent claims. Embodiments are the subject matter of the dependent claims and of the following description.

The invention proposes a method for reducing the content of nitrogen oxides in a flue gas stream, in which the flue gas stream is taken from a thermal plant for the treatment of garbage, domestic waste, and/or residual materials similar to domestic waste, and is passed through a secondary treatment unit configured for selective, non-catalytic reduction, and then is subsequently passed through a scrubbing, absorption, or adsorption unit. According to the invention, it is provided that an ozone injection into the flue gas stream is carried out downstream of the secondary treatment unit and upstream of the scrubbing, absorption, or adsorption unit.

The reduction reaction for the selective, non-catalytic reduction (SNCR) and/or the SCR, for example, with ammonia as the reducing agent, proceeds according to the following equation:

$$6 NO + 4 {NH}_{3} \to 5 {N}_{2} + 6 {H}_{2} O$$

When ozone is used, it can be injected into the flue gas stream upstream of a scrubber unit. The nitrogen oxides, nitrogen monoxide and nitrogen dioxide, are selectively oxidized to dinitrogen pentoxide, an extremely water-soluble species, by the following reactions:

$$NO + {O}_{3} \to {NO}_{2} + {O}_{2} \qquad ( g )$$

$$2 {NO}_{2} + {O}_{3} \to {N}_{2} {O}_{5} + {O}_{2} \qquad ( g )$$

$${N}_{2} {O}_{5} + {H}_{2} O \to 2 {HNO}_{3} \qquad ( l )$$

$${HNO}_{3} + NaOH \to {NaNO}_{3} + {H}_{2} O \qquad ( l )$$

SNCR is the most cost-effective secondary measure. It is carried out in the temperature range between 70° and 1200° C., but its ability to reduce nitrogen oxides is limited; and there is the disadvantage that the escape of ammonia increases at lower nitrogen oxide thresholds. Ammonia itself is a gas with climate effects, and is also subject to strict emission limits.

SCR requires very high investment outlays. It is carried out in the temperature range between 20° and 400° C. The flue gas therefore often has to be heated to these temperatures, which increases the operating costs and reduces the efficiency of the plant.

The reduction of nitrogen oxides with ozone can take place at low temperatures between 50° C. and 200° C. It therefore appears particularly attractive. Nitrogen oxide values below 20 mg/m³ were achieved with ozone.

Based on the chemical equations indicated above, an ozone/nitric oxide mole ratio of 1.5 is required, wherein all of the nitric oxide is first converted into nitrogen dioxide, and then into dinitrogen pentoxide. In industrial applications, mole ratios of more than 1.5, and sometimes even more than 2, are required, since ozone decomposes or is consumed by other substances present in the flue gas.

The production of ozone requires oxygen and energy. The generation of large quantities of ozone thus causes high operating costs.

Although the injection of ozone into the flue gas can supply the lowest possible nitrogen oxide emissions, a considerable amount of energy is required for generating ozone with an ozone generator. This means that the operating costs can be higher than in alternative technologies, such as SCR and SNCR.

The proposed invention lowers the operating costs by considerably reducing the quantity of ozone required to lower the nitrogen oxide emissions to a specific threshold. The coupled operation using SNCR and ozone injection can react cost-effectively to current market prices, and adapt the separation of nitrogen oxides by SNCR and/or ozone injection. A higher proportion of the nitrogen oxide reduction is preferably carried out with the method which is more cost effective at the time.

Ozone is used in industry only in a limited number of applications for reducing nitrogen oxide emissions; most of these applications are carried out in refineries. Compared to alternative technologies, such as SCR and SNCR, in combustion plants, waste treatment plants, or furnaces, ozone has not previously been used. But very strict thresholds for nitrogen oxide emissions and ammonia seem to endorse this technology, since the lowest nitrogen oxide values can be achieved with it.

In particular, SNCR systems may have difficulty in the future satisfying the required thresholds for nitrogen oxides, and at the same time reducing ammonia escape. Operators must invest in an alternative technology in order to achieve the required thresholds.

The combination of SNCR and ozone injection according to the invention is capable of achieving the statutory nitrogen oxide emission limits, and offers economic advantages compared to SCR. Furthermore, retrofitting existing SNCR systems is possible, since the ozone injection is a retrofit technology.

According to one embodiment of the invention, the scrubbing, absorption, or adsorption unit has or is designed itself as a dry, semi-dry or wet scrubber, an ionizing wet scrubber, a spray absorber, or an adsorber. A corresponding scrubbing, absorption, or adsorption unit can, for example, perform a scrubbing using a scrubbing solution, such as lime (calcium hydroxide), sodium hydroxide or potassium hydroxide. In further embodiments of the invention, which are explained further below, sodium nitrite in particular can be formed in a corresponding scrubbing, absorption, or adsorption unit.

According to one embodiment of the invention, the content of the nitrogen oxides in the SNCR—that is, the secondary treatment unit—are reduced to 60 mg/m³ to 250 mg/m³, wherein an extremely low ammonia escape is advantageously ensured, such that an ammonia content downstream of the secondary treatment unit is in particular not more than 10 mg/m³.

According to one embodiment of the invention, the content of nitrogen oxides is further reduced to 0 mg/m³ to 120 mg/m³ by injection of ozone. Ozone can thus be used in order to further reduce the nitrogen oxide emissions to the required low thresholds, so that the upstream SNCR does not have to reach the low values—which may involve a risk of ammonia escape.

The advantages of the two methods—SNCR as the most cost-effective secondary measure for nitrogen oxide reduction, and ozone as the method for achieving the lowest nitrogen oxide—are thus combined in a particularly advantageous manner.

According to one embodiment of the invention, an injection of ammonia or urea into the flue gas stream is carried out in the secondary treatment unit or upstream of the secondary treatment unit and downstream of the flue gas source at a temperature of from 700° C. to 1200° C.

According to this embodiment of the invention, a portion of the nitrogen oxides, comprising at least a portion of nitrogen monoxide, can be reduced in the secondary treatment unit to nitrogen and water.

According to one embodiment of the invention, the flue gas stream can be guided through at least one further treatment unit, designed as or comprising a waste heat boiler, downstream of the secondary treatment unit and upstream of the ozone injection. In this way, a particularly suitable temperature can be achieved for the use of the ozone.

According to one embodiment of the invention, the flue gas stream in the at least one further treatment unit can be cooled to a temperature of from 50° C. to 200° C.

According to one embodiment of the invention, nitrogen oxides can be converted to nitrogen dioxide and further to dinitrogen pentoxide by the ozone injection, as already explained in principle above.

According to an alternative embodiment of the invention, however, a substoichiometric quantity (in particular a quantity of less than 1.5 ozone/nitric oxide) can also be injected during the ozone injection, so that nitrogen oxides are only partially converted to nitrogen dioxide, and the nitrogen dioxide is not converted, or only partially further converted, to dinitrogen pentoxide.

As recognized within the scope of the present invention, a secondary reaction can occur in particular in a wet liquor scrubber downstream of the ozone injection, for large-scale use, which secondary reaction leads to a higher efficiency and controllability of the nitrogen oxide emission reduction. A wet liquor scrubbing solution of sodium hydroxide was used in the large-scale tests. As can be seen from the following reaction equation, due to the only partial oxidation of nitrogen monoxide to nitrogen dioxide, a reaction of nitrogen monoxide, nitrogen dioxide, and sodium hydroxide to sodium nitrite, and not sodium nitrate, as is known from the prior art, is accordingly carried out.

$$NO + {NO}_{2} + NaOH \to 2 {NaNO}_{2} + {H}_{2} O$$

This reaction also applies to other wet scrubbing solutions in which hydroxide ions are present, which form nitrite and water.

According to this embodiment of the invention, in other words, nitrogen monoxide and nitrogen dioxide can be converted at least partially with hydroxide ions to sodium nitrite and water in the scrubbing, absorption, or adsorption unit.

A system for reducing the content of nitrogen oxides in a flue gas stream, with a secondary treatment unit configured for selective, non-catalytic reduction, and a scrubbing, absorption, or adsorption unit, is likewise the subject matter of the invention. The system is configured to remove the flue gas stream from a flue gas source producing nitrogen oxides, and to pass it through the secondary treatment unit configured for selective, non-catalytic reduction and subsequently through the scrubbing, absorption, or adsorption unit. According to the invention, the system has means for injection of ozone, which are configured to inject ozone into the flue gas stream downstream of the secondary treatment unit and upstream of the scrubbing, absorption, or adsorption unit.

With regard to the arrangement provided according to the invention and its features, reference is expressly made to the above explanations of the method according to the invention and its embodiments, since these likewise concern a corresponding arrangement. The same applies in particular to an embodiment of a corresponding arrangement which is advantageously configured for carrying out a corresponding method in any embodiment.

As already mentioned, all embodiments of the present invention have the advantage that significantly less ozone is required in order to reduce the same quantity of nitrogen oxides. However, a further reduction of the emissions of nitrogen oxides can also be achieved with the same quantity of ozone. In some cases, nitrogen oxide emissions close to zero can be achieved.

The invention takes a special approach to meeting the requirements of the thermal treatment of garbage, domestic waste, and/or residual materials similar to domestic waste, by an adapted control and coupling of the two methods, SNCR and ozone injection. The special requirements result from the fact that, in the thermal treatment of garbage, domestic waste, and/or residual materials similar to domestic waste, due to the inhomogeneity of the fuel, with the fuel being treated at the time having an unknown composition, frequent short-term fluctuations of the combustion intensity and thus of the exhaust gas composition occur. This results in particular from the varying humidity and the varying ignition behavior of the supplied fuel. This is not the case in fuels, such as coal, single-type biomass, oil or gas with predictable composition. In contrast, the control of the thermal waste treatment must react to short-term, non-foreseeable events in order to reliably reduce emissions.

In the nitrogen oxide concentration in the flue gas stream upstream of the secondary treatment unit, this means, for example, that short-term fluctuations of up to 200 mg/Nm³—with a base level of 350-450 mg/Nm³—can occur in a few minutes in the thermal waste treatment.

In one embodiment of the invention, it is provided to adapt the selective, non-catalytic reduction in the secondary treatment unit to the long-term base level of nitrogen oxides. The secondary treatment unit is operated such that a certain nitrogen content present in the flue gas in the long term is reduced. By contrast, the operation does not react to short-term fluctuations in nitrogen content—in contrast to the earlier approach in the prior art. This has the advantage that the added quantity of ammonia or urea does not have to be readjusted for short-term fluctuations in order to achieve a robust nitrogen oxide reduction. The control principle according to fluctuations known from the prior art is problematic, since short-term increases in the nitrogen oxide concentration before the ammonia injection and/or before the urea injection are efficiently treated by the slow reaction and an uneven distribution of the ammonia or urea, resulting in higher nitrogen oxide emissions.

The invention provides the adaptation of the quantity of ozone to reduce fluctuating nitrogen oxide emissions. The reduction of nitrogen oxides by the addition of ozone is a very fast process. The oxidation of the nitrogen oxides takes place within a few milliseconds, and the quantity of ozone produced can also be quickly adapted to current nitrogen oxide concentrations in the order of several seconds. It is therefore technically possible to effectively treat fluctuating nitrogen oxide concentrations in the flue gas which result from the thermal waste treatment with active SNCR.

In order to further reduce the quantity of ozone in a further embodiment of the invention, the ozone quantity at any given time is provided in accordance with the pH of the scrubbing, absorption, or adsorption unit. As already explained above, a mole ratio of 1.5 ozone/nitric oxide is required in order to oxidize all of the nitric oxide—i.e., to convert it first into nitrogen dioxide and then into dinitrogen pentoxide. In industrial applications, mole ratios of more than 1.5 are usually required.

According to the invention, it has been shown that, in accordance with the pH of the downstream scrubbing unit, a complete oxidation of the nitrogen oxides to dinitrogen pentoxide is not required in order to remove them from the flue gas stream. If the scrubbing unit is operated under non-acidic conditions, it is sufficient to oxidize nitrogen monoxide only to nitrogen dioxide. In an alkaline scrubbing solution, the nitrogen dioxide forms nitrite and water with hydroxide ions. Accordingly, in non-acidic conditions in the scrubbing unit, it is not necessary to oxidize the nitrogen oxides completely to dinitrogen pentoxide in order to remove them from the flue gas stream. This means that less ozone is required.

In one embodiment of the invention, therefore, at a pH greater than 7.5 in the scrubbing unit, only enough ozone is injected into the flue gas stream so that the mole ratio between the nitrogen monoxide upstream of the ozone injection and the injected ozone is between 0.5 and 1.5, between 0.5 and 1.4, between 0.5 and 1.2, or between 0.5 and 1.0.

If the scrubbing unit is operated at a pH below 7.5, in contrast more ozone is injected in order to oxidize the nitrogen oxides completely to form dinitrogen pentoxide. Preferably, therefore, at a pH below 7.5 in the scrubbing unit, the ozone injection is controlled such that the mole ratio between the nitrogen monoxide upstream of the ozone injection and the injected ozone is 1.5 or more, or is between 1.5 and 2.5 or between 1.5 and 2.0.

The invention is explained in more detail below with reference to the accompanying drawings, which illustrate embodiments of the present invention.

### DESCRIPTION OF THE FIGURES

FIG. 1 illustrates a method, and an arrangement, according to an embodiment of the present invention.

In the following figures, elements that correspond to one another functionally or structurally are indicated by identical reference symbols and for the sake of clarity are not repeatedly explained. If components of apparatuses are explained below, the corresponding explanations also in each case relate to the methods carried out therewith, and vice versa.

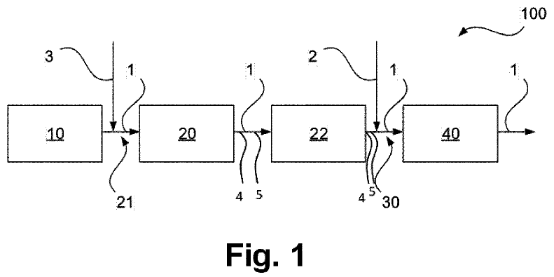

The method illustrated in FIG. 1, which is denoted overall by 100, serves to reduce the content of nitrogen oxides in a flue gas stream 1, which is taken from a flue gas source 10 producing nitrogen oxides, for example a combustion plant, a waste treatment plant or a furnace.

In the embodiment illustrated here, the flue gas stream designated by 1 is passed through a secondary treatment unit 20 configured for selective, non-catalytic reduction, and further downstream is passed through a scrubbing, absorption, or adsorption unit 40.

In the embodiment of the invention illustrated here, an ozone injection 30 is carried out in the flue gas stream 1 downstream of the secondary treatment unit 20 and upstream of the scrubbing, absorption, or adsorption unit 40. A corresponding ozone flow (or flow of an ozone-rich gas) is indicated by 2.

As shown in FIG. 1, the flue gas stream 1 is passed, downstream of the secondary treatment unit 20 and upstream of the ozone injection 30, through at least one further treatment unit 22, designed as or comprising a waste heat boiler, and is cooled accordingly.

As likewise shown in FIG. 1, an injection, denoted by 21, of ammonia or urea into the flue gas stream 1 is carried out in the secondary treatment unit 20 or upstream of the secondary treatment unit 20 and downstream of the flue gas source 10 at a temperature as explained above, wherein an ammonia or urea stream is denoted by 3.

As shown in FIG. 1, the nitrogen oxide concentration 4 and the ammonia concentration 5 are measured upstream and downstream of the ozone injection 30.

1. A method for reducing the content of nitrogen oxides in a flue gas stream, wherein the flue gas stream is taken from a thermal plant for the treatment of garbage, domestic waste, and/or residual materials similar to domestic waste and is passed through a secondary treatment unit configured for selective, non-catalytic reduction, and then is subsequently passed through a scrubbing, absorption, or adsorption unit, wherein an ozone injection into the flue gas stream is carried out downstream of the secondary treatment unit and upstream of the scrubbing, absorption, or adsorption unit.

2. The method according to claim 1, wherein the nitrogen oxide concentration and ammonia concentration of the flue gas stream are determined upstream and/or downstream of the ozone injection.

3. The method according to either claim 1, wherein the secondary treatment unit is set to a base quantity of nitrogen oxides, and that a quantity of ozone that compensates for short-term fluctuations in the nitrogen concentration in the flue gas stream is injected into the flue gas stream.

4. The method according to claim 1, wherein the ozone injection is controlled, at a pH below 7.5 in the scrubbing unit, in such a manner that the mole ratio between the nitrogen oxide concentration upstream of the ozone injection and the injected ozone is between 1.5 and 2.5, and that the ozone injection is controlled, at a pH of greater than 7.5 in the scrubbing unit, in such a manner that the mole ratio between the nitrogen oxide concentration upstream of the ozone injection and the injected ozone is between 0.5 and 1.5.

5. The method according to claim 1, wherein ammonia is metered into the flue gas stream in the secondary treatment unit, and that the quantity of metered ammonia and the quantity of injected ozone are controlled in accordance with current market prices.

6. The method according to claim 1, wherein the scrubbing unit has or is itself designed as a dry, semi-dry or wet scrubber, an ionizing wet scrubber, a spray absorber, or an adsorber.

7. The method according to claim 1, wherein the content of the nitrogen oxides in the secondary treatment unit is reduced to 60 mg/m³ to 250 mg/m³, and wherein an ammonia content downstream of the secondary treatment unit is not more than 10 mg/m³.

8. The method according to claim 7, wherein the content of nitrogen oxides is further reduced by the injection of ozone to 0 mg/m³ to 120 mg/m³.

9. The method according to claim 1, wherein an injection of ammonia or urea into the flue gas stream is carried out in the secondary treatment unit or upstream of the secondary treatment unit and downstream of the flue gas source at a temperature of from 700° C. to 1200° C.

10. The method according to claim 1, wherein a portion of the nitrogen oxides, comprising at least a portion of nitrogen monoxide, is reduced in the secondary treatment unit to nitrogen and water.

11. The method according to claim 1, wherein the flue gas stream is passed, downstream of the secondary treatment unit and upstream of the ozone injection, through at least one further treatment unit, designed as or comprising a waste heat boiler.

12. The method according to claim 11, wherein the flue gas stream is cooled in the at least one further treatment unit to a temperature of from 50° C. to 200° C.

13. The method according to claim 1, wherein nitrogen oxides are converted to nitrogen dioxide and further to dinitrogen pentoxide by the injection of ozone.

14. The method according to claim 1, wherein a substoichiometric quantity of ozone is injected during the ozone injection, such that nitrogen monoxide is only partially converted to nitrogen dioxide, and the nitrogen dioxide is not converted or is only partially further converted to dinitrogen pentoxide.

15. The method according to claim 14, in which nitrogen monoxide and nitrogen dioxide are reacted at least partially with hydroxide ions to form sodium nitrite and water in the scrubbing, absorption, or adsorption unit.
